(19) United States
(12) Patent Application Publication
(10) Pub. No.: US 2023/0147668 A1
(43) Pub. Date: May 11, 2023

(54) DEFECT TRACKING AND REMEDIATION USING CLIENT-SIDE SCREEN RECORDING

(71) Applicant: International Business Machines Corporation, Armonk, NY (US)

(72) Inventors: Pavan Kumar Penugonda, Anakapalle (IN); Venkata Ratnam Alubelli, Visakhapatnam (IN); Saraswathi Sailaja Perumalla, Visakhapatnam (IN); Gowri Pruthvi, Hyderabad (IN); Sekhar Reddy Dandu Reddy, Visakhapatnam (IN)

(21) Appl. No.: 17/524,163

(22) Filed: Nov. 11, 2021

(51) Int. Cl. G06F 11/07; G06F 40/40

(52) U.S. Cl. CPC G06F 11/079; G06F 11/0751; G06F 11/0772; G06F 11/0793; G06F 40/40

(57) ABSTRACT

A computer system provides performs defect tracking and remediation. Video data is received, from a client computing device, corresponding to a recording of a graphical user interface of an application of the client computing device, wherein the video data is obtained in response to the application encountering an error. Feedback is obtained from a user of the client computing device by engaging the user via a natural language processing model. The video data and the feedback are analyzed to determine one or more operations to reproduce the error. One or more corrective actions, based on the determined one or more operations, are provided to remediate the error in the application. Embodiments of the present invention further include a method and program product for performing defect tracking and remediation in substantially the same manner described above.

### BACKGROUND

### 1. Technical Field

Present invention embodiments relate to root cause analysis, and more specifically, to tracking and remediating defects in software-as-a-service applications using client-side screen recording techniques.

### 2. Discussion of the Related Art

Software as a service (SaaS) is a software licensing and delivery model in which software is licensed on a subscription basis and is centrally hosted. SaaS, also referred to as “on-demand” software, “Web-based” software, or “Web-hosted” software, is typically provided by a server that is accessed using a client-side application, such as a web browser. In SaaS-based applications, a same server can be used by a wide variety of client devices. Typically, when a software application encounters an error, developers determine how to reproduce the error; once the root cause of the error is known, developers can provide a fix for the application. It can be difficult to reproduce errors in SaaS-based applications, as reproducing an error may require a particular client-side hardware or software configuration that the server cannot detect.

### SUMMARY

According to one embodiment of the present invention, a computer system performs defect tracking and remediation. Video data is received, from a client computing device, corresponding to a recording of a graphical user interface of an application of the client computing device, wherein the video data is obtained in response to the application encountering an error. Feedback is obtained from a user of the client computing device by engaging the user via a natural language processing model. The video data and the feedback are analyzed to determine one or more operations to reproduce the error. One or more corrective actions, based on the determined one or more operations, are provided to remediate the error in the application. Embodiments of the present invention further include a method and program product for defect tracking and remediation in substantially the same manner described above.

### BRIEF DESCRIPTION OF THE DRAWINGS

Generally, like reference numerals in the various figures are utilized to designate like components.

FIG. 1 is a block diagram depicting a computing environment for defect tracking and remediation in accordance with an embodiment of the present invention;

FIG. 2 is a block diagram depicting a workflow for defect tracking and remediation in accordance with an embodiment of the present invention;

FIG. 3 is a flow chart depicting a method of monitoring and collecting video data in accordance with an embodiment of the present invention;

FIG. 4 is a flow chart depicting a method of performing defect tracking and remediation in accordance with an embodiment of the present invention; and

FIG. 5 is a block diagram depicting a computing device in accordance with an embodiment of the present invention.

### DETAILED DESCRIPTION

Present invention embodiments relate to root cause analysis, and more specifically, to tracking and remediating defects in software-as-a-service (SaaS) applications using client-side screen recording techniques. In order to reproduce a defect, and therefore determine the root cause of the defect, it is helpful to have knowledge of the full context in which the defect occurred, including server-side details as well as client-side details. For example, a particular defect may only occur on a client device that is running a particular version of software, and then, only when the user provides a specific combination of inputs or commands.

In order to capture the client-side context of a defect in SaaS-based applications, present invention embodiments capture video data of the client device's graphical user interface, which enables inspection and analysis of the client-side context of the defect. Video data capturing a span of time leading up to a defect can be obtained from a client device automatically when a defect occurs, and the video data can be analyzed to identify actions performed by the user as well as any symptoms of the defect (e.g., an operation taking longer than normal, etc.). Furthermore, a chat bot that utilizes a natural language processing model can have a conversation with the user to extract user feedback about the events leading up to the defect. Defects can be identified based on error codes or by detecting a deviation from the baseline performance of applications. Additionally, the root cause of a defect can be determined automatically, and corrective actions can also be performed automatically, thus enabling a fully automatic, streamlined defect monitoring and remediation system to be provided.

Accordingly, present invention embodiments provide the practical application of improving the field of root cause analysis by providing techniques for defect tracking and remediation that can be fully automated. By performing local screen recording, the client-side context of defects can be captured and studied to determine how to reproduce and fix the defects. Additionally, present invention embodiments reduce the amount of data required to perform defect tracking and remediation by assessing defects based on their particular nature or severity, and accordingly saving, transmitting, and analyzing a predetermined amount of video data leading up to the occurrence of the defect. In particular, more critical defects may be associated with a larger span of video data preceding those defects, whereas less critical defects may capture a shorter amount of video data. Accordingly, present invention embodiments can optimize the data footprint of defect tracking and remediation, thereby reducing data utilization and computer processing requirements. Additionally, present invention embodiments can apply natural language processing techniques to obtain from a user any relevant details relating to a defect. Thus, the embodiments presented herein improve the technical field of root cause analysis by providing automated solutions for defect tracking and remediation.

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of embodiments of the invention as set forth hereinafter.

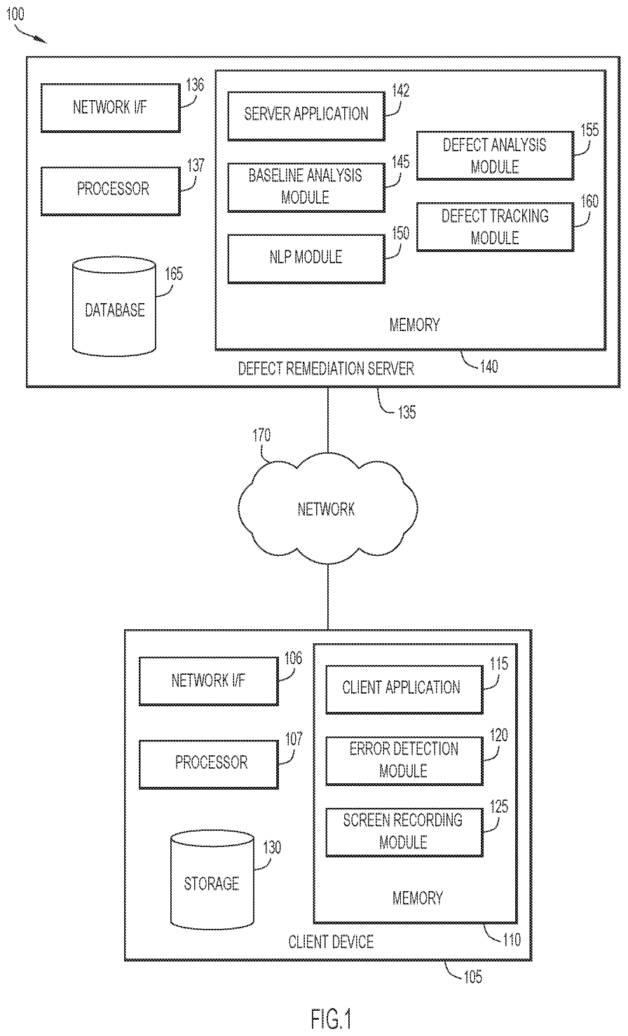

Present invention embodiments will now be described in detail with reference to the Figures. FIG. 1 is a block diagram depicting a computing environment 100 for defect tracking and remediation in accordance with an embodiment of the present invention. As depicted, computing environment 100 includes a client device 105, a defect remediation server 135, and a network 170. It is to be understood that the functional division among components of computing environment 100 have been chosen for purposes of explaining present invention embodiments and is not to be construed as a limiting example.

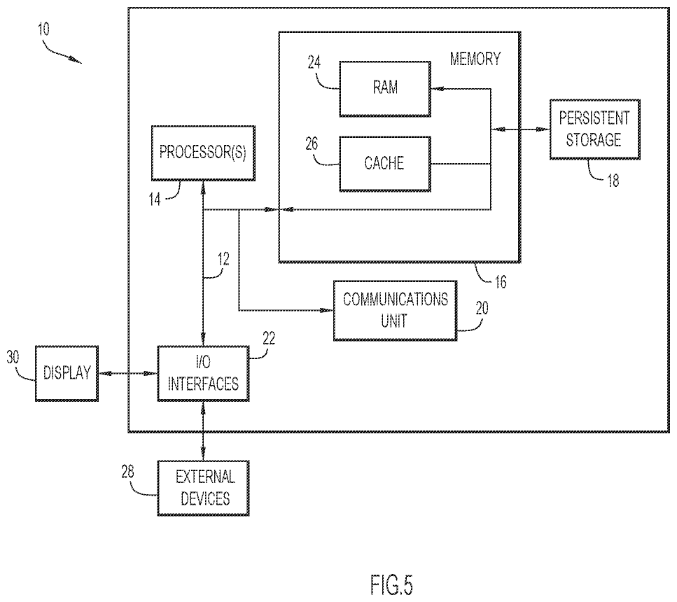

Client device 105 includes a network interface (I/F) 106, at least one processor 107, memory 110, and storage 130. Memory 110 may include a client application 115, an error detection module 120, and a screen recording module 125. Client device 105 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 106 enables components of client device 105 to send and receive data over a network, such as network 170. In general, client device 105 enables a user to use a SaaS-based application that receives data from a server and/or provides data to a server in order to perform at least some operations. Client device 105 may include internal and external hardware components, as depicted and described in further detail with respect to FIG. 5.

Client application 115, error detection module 120, and screen recording module 125 may include one or more modules or units to perform various functions of present invention embodiments described below. Client application 115, error detection module 120, and screen recording module 125 may be implemented by any combination of any quantity of software and/or hardware modules or units, and may reside within memory 110 of client device 105 for execution by a processor, such as processor 107.

Client application 115 may include any client for an application that also performs server-side operations. In particular, client application 115 may include a SaaS-based application, such as a single page application or web-based application. In some embodiments, client application 115 is a web browser that presents a web page that serves as a user interface. A user may provide input to client application 115, including data, selections, commands, and the like, which can be sent to a server (e.g., defect remediation server) for further processing. For example, a user of client device 105 may access a server via client application 115 to view, enter, or modify data being presented in a spreadsheet interface. In this example, when the user enters data into a particular cell of the spreadsheet interface, the data is provided to the server, where the data is stored, and if the data includes a command, the server may perform the command, store the results, and update the client-side spreadsheet interface with the stored results.

Error detection module 120 may detect defects in client application 115 so that a screen recording can be captured that includes a video of events preceding the occurrence of the detected defect. In some embodiments, error detection module 120 detects a defect on the basis of an error message or other notification being presented by client application 115. For example, a web-based application may encounter an Hypertext Transfer Protocol (HTTP) 404 error that indicates that a requested page or file cannot be found. In some embodiments, error detection module 120 determines that a defect has occurred when client application 115 deviates from a baseline value that is predetermined and based on the expected performance and/or capabilities of client application 115. The baseline values can include performance values, such as expected times for processing requests, expected client-side and/or server-side computing resource utilization (e.g., processing resource utilization, memory resource utilization, and storage resource utilization). Additionally or alternatively, the baseline values can include known behaviors of client application 115. Thus, if new behaviors are encountered, such as new features being introduced, existing features being modified, or existing features being removed, error detection module 120 may detect a defect as a result of the presence of a deviation from the baseline values (even though this may not constitute an error per se).

Screen recording module 125 may obtain a screen recording that includes time-series video data of a window or span of time before and/or after an error is detected by error detection module 120. In some embodiments, screen recording module 125 is a plug-in or extension of client application 115. For example, client application 115 may include a web browser, and screen recording module 125 may be a browser extension. Screen recording module 125 may perform constant screen recording during usage of client application 115 by a user, and, when an error is encountered, may extract a portion of the recorded video data that includes a particular span of time around the occurrence of the error. Thus, screen recording module 125 can ensure that there is video data available in the event of an error. In order to reduce the volume of data that is stored, screen recording module 125 may discard video data that exceeds a predetermined age. For example, screen recording module 125 may only maintain a recording of video data from a last hour, as it is unlikely that any action performed by a user more than one hour ago is relevant to an error that has just occurred.

Screen recording module 125 may record the graphical user interface of client application 115. In various embodiments, screen recording module 125 records the entire graphical user interface of client device 105 or may only record a portion of the graphical user interface that relates to client application 115 (e.g., the window of client application 115). Screen recording module 125 may record the video data as a series of timestamped screenshots. The video data obtained by screen recording module 125 may have a framerate that matches the refresh rate of the display of client device 105 (e.g., 60 frames per second for a 60 Hertz display), or the video data may have a higher or lower framerate than the refresh rate of the display of client device 105. The video data may also include any associated user inputs, such as keystrokes, mouse clicks and locations, and the like. In some embodiments, any confidential or sensitive data presented in the user interface is automatically identified and blurred in the video data that is uploaded to defect remediation server 135.

Screen recording module 125 may select a portion of the saved video data that relates to the occurrence of an error, including a portion of video data preceding the error, a portion of video data after occurrence of the error, or both. In some embodiments, screen recording module 125 selects a predetermined length of video data, such as video data corresponding to the minute preceding the error. In some embodiments, error detection module 120 categorizes the error, and based on the error category, screen recording module 125 determines how much video data to select. For example, screen recording module 125 may obtain a greater span of video data for an error associated with a high severity (e.g., as determined by the error category) than for a less-severe error. The data that is selected as being associated with an error is then provided to defect remediation server 135 for further analysis.

Storage 130 may include any non-volatile storage media known in the art. For example, storage 130 can be implemented with a tape library, optical library, one or more independent hard disk drives, or multiple hard disk drives in a redundant array of independent disks (RAID). Similarly, data in storage 130 may conform to any suitable storage architecture known in the art, such as a file, a relational database, an object-oriented database, and/or one or more tables. In some embodiments, storage 130 may store data including any logs associated with client application 115, including error logs and performance logs, and/or storage 130 may store video data collected by screen recording module 125.

Defect remediation server 135 includes a network interface (I/F) 136, at least one processor 137, memory 140, and a database 165. Memory 140 may include a server application 142, a baseline analysis module 145, a natural language processing (NLP) module 150, a defect analysis module 155, and a defect tracking module 160. Defect remediation server 135 may include a laptop computer, a tablet computer, a netbook computer, a personal computer (PC), a desktop computer, a personal digital assistant (PDA), a smart phone, a thin client, a rack-mounted server, or any programmable electronic device capable of executing computer readable program instructions. Network interface 136 enables components of defect remediation server 135 to send and receive data over a network, such as network 170. In general, defect remediation server 135 provides server-side support for SaaS-based applications, and/or analyzes and tracks defects in SaaS-based applications. Defect remediation server 135 may include internal and external hardware components, as depicted and described in further detail with respect to FIG. 5.

Server application 142, baseline analysis module 145, NLP module 150, defect analysis module 155, and defect tracking module 160 may include one or more modules or units to perform various functions of present invention embodiments described below. Server application 142, baseline analysis module 145, NLP module 150, defect analysis module 155, and defect tracking module 160 may be implemented by any combination of any quantity of software and/or hardware modules or units, and may reside within memory 140 of defect remediation server 135 for execution by a processor, such as processor 137.

Server application 142 provides server-side functionality to support SaaS-based applications, such as client application 115 of client device 105. Server application 142 may perform any operations, including requests to process, store, and/or retrieve data. For example, a SaaS-based application may request certain records in a database managed by server application 142, which will retrieve the records and transmit the records to the application. Server application 142 may log performance attributes, including its network utilization (e.g., how much data is being transmitted, transfer speeds, latency, etc.), and/or its computing resource utilization (e.g., processor utilization, memory utilization, storage utilization), as well as the network and/or computing resource utilization of client applications, which can be based on data collected from the client applications.

Baseline analysis module 145 determines the baseline values for performance and behavior of SaaS-based applications that are supported by defect remediation server 135. Data can be collected during development phases (e.g., quality assurance) and/or during end-user usage of applications regarding the behavior of an application, and the collected data can be analyzed using statistical techniques to generate baseline values. In some embodiments, the baseline values for performance are determined by monitoring computing resource usage of applications during execution. Baseline values can be determined for any level of granularity, including as an overall average baseline for computing resource utilization, baseline values for certain pages or views of an application, baseline values for execution of particular functions, and the like. In some embodiments, baseline values for application behavior can be determined, which may or may not include user behavior. The baseline values for application behavior may include average dwell time of particular views of the application (e.g., any particular user interface element or combination of user interface elements). In some embodiments, the baseline values include average response times that client application 115 experiences (e.g., while waiting on defect remediation server 135 to respond to a particular request). In some embodiments, the baseline values include accessing features of client application 115. For example, when a user uses a newly-added feature, accesses a new view, and the like, the new behavior may be considered a departure from baseline values, which reflect any of the application's previously-known features, views, etc. The determined baseline values can then be provided to client applications to detect deviations from baselines, and/or can be used server-side to detect deviations from baselines.

NLP module 150 may include one or more trained machine learning models that perform natural language processing to provide a chat bot for discussing defects with users. The chat bot may engage in a dialogue with a user via a question-and-answer approach in order to extract user feedback relating to a defect that the user has encountered while using a SaaS-based application. NLP module 150 may initiate a dialogue using a chat bot to present questions to a user of client device 105 in response to a defect being detected. Thus, the user can provide feedback to explain what the user was doing at the time of the defect, which can help narrow down particular features or operations of the software that might be relevant to reproduce the defect. The natural language processing model employed by NLP module 150 may include a bidirectional encoder representations from transformers (BERT) model, a generative pre-trained transformer (GPT) model, and the like, and may be trained with examples of questions that a chat bot can ask that are associated with particular types of defects. Thus, NLP module 150 can direct a chat bot to ask relevant questions and collect user feedback that is germane to the particular defect encountered by the user.

Defect analysis module 155 may analyze data collected about a defect, including video data, user feedback data, and/or application performance data, to identify how to reproduce the defect and accordingly, determine a fix for the defect. In some embodiments, defect analysis module 155 may employ conventional or other machine learning models to perform pattern analysis by comparing the video data, user feedback data, and/or application performance data to similar data that is associated with a knowledge base of other defects. The knowledge base may store instructions to reproduce known defects and solutions to the defects. Thus, defect analysis module 155 can identify other defects that are most similar to the current defect, and apply same or similar operations to reproduce and/or fix the defect.

In some embodiments, defect analysis module 155 may analyze the video data to identify each operation that a user performed at client application 115 in a span of time leading up to the defect. Operations can be identified based on user interface elements with which the user interacted, such as commands entered, selections or actuations made via mouse clicks, and the like. Similarly, defect analysis module 155 can extract events from the user's feedback and application performance data events, such as spikes in processer utilization, to create a time-series history of events leading up to a defect. This time-series history of events can include both quantitative and qualitative data, and can serve as the basis for pattern recognition by the machine learning model. In some embodiments, a vector space model may be used, and the time-series history of events can be converted into a n-dimensional vector; the machine learning model may thus identify similar vectors (e.g., using cosine similarity) that are associated with defects most similar to the current defect. In some embodiments, the machine learning model may include a multidimensional classification model, such as a Bayesian model, neural network, and the like, that is trained to identify classes of defects based on the events leading up to the defects (e.g., the time-series history of events).

Once defect analysis module 155 determines actions to reproduce and/or remediate a defect, those actions can be shared to client device 105 or applied automatically to client application 115 and/or server application 142 via updates in order to remediate the defect. Defect analysis module 155 may also share instructions for reproducing and/or remediating defects with defect tracking module 160 for storage in a release notes document (e.g., a user guide).

Defect tracking module 160 may track known defects of a SaaS-based application by storing with each defect any known video data, user feedback, instructions to reproduce the defect, and/or instructions to remediate the defect. Accordingly, defect tracking module 160 may maintain a knowledge base of defects. The knowledge base may be updated in response to new data being collected or generated regarding a defect. In some embodiments, natural language processing techniques can be employed to process an application's defect data stored in the knowledge base to automatically produce a comprehensive release notes document that can be used by end-users and/or developers for troubleshooting or other purposes. The release notes documents may present known defects according to particular views of application 115 by identifying any defects that are tagged or otherwise associated with each view.

Database 165 may include any non-volatile storage media known in the art. For example, database 165 can be implemented with a tape library, optical library, one or more independent hard disk drives, or multiple hard disk drives in a redundant array of independent disks (RAID). Similarly, data in database 165 may conform to any suitable storage architecture known in the art, such as a file, a relational database, an object-oriented database, and/or one or more tables. In some embodiments, database 165 may store data including a knowledge base of defect data (e.g., known defects, video data, user feedback data, instructions for reproducing defects, instructions for remediating defects, etc.) as well as data relating to SaaS-based applications, such as any data stored server-side. Database 165 may also store baseline value data.

Network 170 may include a local area network (LAN), a wide area network (WAN) such as the Internet, or a combination of the two, and includes wired, wireless, or fiber optic connections. In general, network 170 can be any combination of connections and protocols known in the art that will support communications between client device 105 and defect remediation server 135 via their respective network interfaces in accordance with embodiments of the present invention.

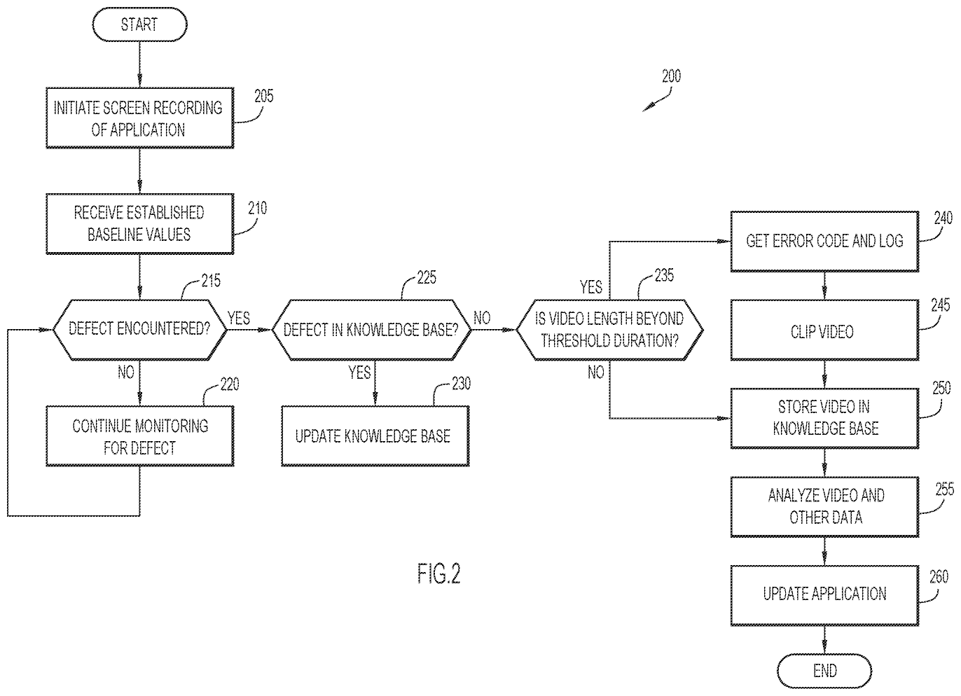

FIG. 2 is a block diagram depicting a workflow 200 for defect tracking and remediation in accordance with an embodiment of the present invention.

Screen recording of an application is initiated at operation 205. The application may include a SaaS-based application, and as such, may be a client-side application that accesses a server to perform at least some operations. The screen recording may capture video of the graphical user interface of the application as a user interacts with the application. Accordingly, any user actions and events in the application can be captured, such as inputting of data, selecting actions to be performed, navigating to particular menus, application responses, operations initiated by the server that affect local execution, and the like.

Established baseline values for the application are received at operation 210. A client computing device, such as client device 105, may receive baseline values that are determined based on previously-observed performance of the application. The baseline values may include performance values, such as expected computing resource utilization, wait times, and the like. Additionally or alternatively, the baseline values can include known behaviors of the application, such as available menus, options, settings, known sequences of operations at runtime, and the like.

Operation 215 determines whether there is a defect in the application. A defect can be identified based on an error code being presented, which can be generated locally or provided from the server in communication with the application. Additionally or alternatively, the defect can be identified based on a deviation or combination of deviations from the baseline values. The defect may also be identified based on user feedback that is acquired by a chat bot using natural language processing techniques. If there is no defect, then the system continues monitoring for a defect at operation 220. Otherwise, operation 225 determines whether the defect is already documented in the knowledge base.

If the defect is already in the knowledge base, then the knowledge base may be updated at operation 230. Any performance data associated with the application can be used to update the baseline values, and optionally, the video data can be added to the knowledge base to further expand the knowledge base's documentation of the defect.

If the defect is not already in the knowledge base, and therefore the defect may be a newly-identified defect, then operation 235 determines whether the length of the acquired video data is beyond a threshold duration. If the video is beyond a threshold duration, then an error code associated with the defect is logged at operation 240, and the video is trimmed at operation 245. In some embodiments, the threshold duration for a video may be determined according to the nature of the defect. Defects that can be categorized (e.g., based on an error code) may be associated with particular threshold durations based on their category. In some embodiments, a default threshold duration may be used in the event that a category cannot be determined for a defect.

At operation 250, the video is stored in the knowledge base. The video data is associated with an identifier for the defect, such as an assigned defect identity, an error code, or other identifier, and stored in the knowledge base for future use. The video data is also associated with feedback from the user and application performance data, which are analyzed at operation 255 to create a time-series history of events leading up to the occurrence of the defect. Thus, any details relating to user activity and/or application behavior can be captured and analyzed to determine the root cause of a defect.

The application is updated at operation 260. The time-series history of events leading up to the occurrence of a defect can be analyzed to automatically identify how to reproduce the defect, and operations to remediate the defect can be determined accordingly. The application can then be updated client-side and/or server-side in order to remediate the defect.

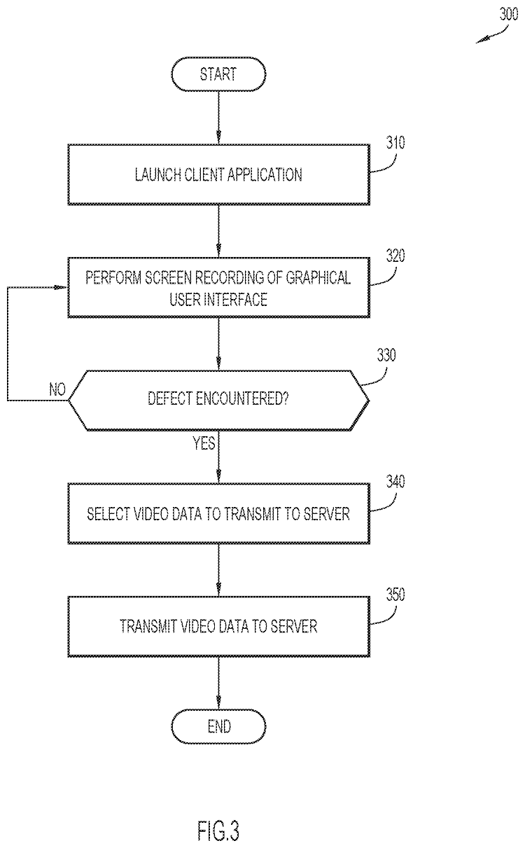

FIG. 3 is a flow chart depicting a method 300 of monitoring and collecting video data in accordance with an embodiment of the present invention.

A client application is launched at operation 310. The client application may be a SaaS-based application, such as client application 115, that communicates with a server-side application, such as server application 142, in order to perform at least some server-side operations. In some embodiments, the client application includes a web browser, and data is fetched from the server and presented to a user in a web page.

Screen recording of a graphical user interface is performed at operation 320. Video data may be captured that corresponds to a portion of a display associated with a graphical user interface of the client application and/or other portions of the display (e.g., other graphical elements such as operating system panes, etc.). The video data may be stored for a predetermined length of time so that the oldest video data can be replaced with recently-collected video data without expanding the overall size of video data that is being stored. Thus, for example, a span of video data corresponding to a last minute, a last ten minutes, or a last hour may be maintained.

Operation 330 determines whether a defect has been encountered. A defect can be identified based on an error code and/or a deviation from baseline values that are predetermined for the application. If a defect occurs, video data is selected to be transmitted to a server at operation 340. Otherwise, screen recording continues along with defect monitoring operations.

In response to a defect occurring, the video data may be processed to select a subset of video data to transmit to a server. The time span of video data and/or data amount of video data that is provided to a server can be determined based on a category of a defect. For example, a defect that is categorized as more severe may indicate collection of more preceding video data (e.g., going farther backward in time) than a less-severe defect.

The selected video data is then transmitted to the server at operation 350. The video data can be provided to a server for further analysis, and once the defect is reproduced, the client application may receive an update to remediate the defect.

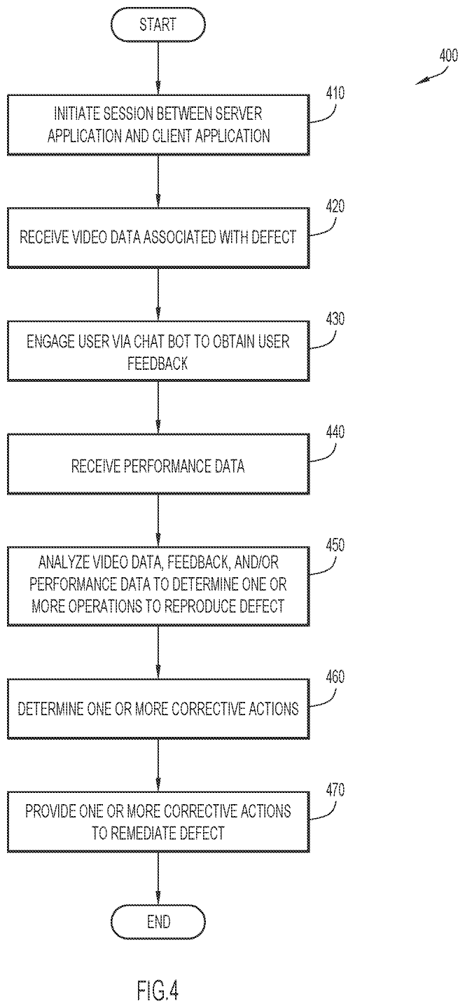

FIG. 4 is a flow chart depicting a method 400 of performing defect tracking and remediation in accordance with an embodiment of the present invention.

A session is initiated between a server application and a client application at operation 410. Once the session is initiated, the server application may support a SaaS-based client application by responding to requests received from the client application, such as requests to provide data or to perform data processing.

Video data associated with a defect is received at operation 420. A server may receive video data from a client device in response to the occurrence of a defect in the client application. Receipt of the video data may itself serve as a notification to the server that the client application has encountered an error, or a separate notification may be provided.

A chat bot is used to engage the user in order to obtain user feedback at operation 430. In response to the server being notified that a defect has been encountered, a chat bot may be employed to converse with the user using a question-and-answer approach that utilizes a natural language processing model. The model may be trained to select particular questions to ask the user based on the nature of the defect, and can thus elicit user feedback that further provides a context of the defect. The user feedback can be free-form feedback that can be further processed using the natural language processing model to classify the user's experience with the defect into one or more predetermined categories (e.g., network error, client-side error, etc.). In some embodiments, the chat bot may present the user with predetermined responses that the user can select.

Performance data is received at operation 440. Performance data may be received from the client device, and can include any details relating to wait times, processor utilization, memory utilization, storage utilization, network utilization, and the like. In some embodiments, similar server-side performance data is also collected and included in the performance data received by the client device.

The video data, user feedback, and/or performance data is analyzed at operation 450 to determine one or more operations to reproduce the defect. The video data, user feedback, and/or performance data can be analyzed to produce a time-series history of events leading up to the occurrence of the defect. The events can include user activity, software operations performed by the client application, deviations from baseline values that exceed a threshold and/or deviations from baseline values that do not exceed a threshold, and the like. The time-series history of events can be analyzed by a machine learning model by applying pattern recognition to identify the particular events that are associated with the defect. For example, a knowledge base may include similar time-series event histories in which a defect was not encountered, and thus, by identifying the differences between time-series histories, the root cause events can be identified.

At operation 460, one or more corrective actions to remediate the defect are determined. The corrective actions can be automatically identified based on the root cause event(s) used to reproduce the defect. For example, if entering a non-numerical character in a field caused the defect, the corrective action may include pushing an update that restricts the user from entering non-numerical characters in the field. In some embodiments, any other affected client devices may be identified based on a similarity of those client devices' behavior and/or configuration (e.g., particular software and/or hardware elements) with the behavior and/or configuration of the client device that is associated with the defect. Thus, other at-risk devices can be notified so that the defect can be avoided by other end users.

The one or more correct operations are provided to remediate the defect at operation 470. The corrective actions can be provided in the form of executable instructions, such as a software update that can be executed at a client device.

FIG. 5 is a block diagram depicting components of a computer 10 suitable for executing the methods disclosed herein. Computer 10 may implement client device 105 and/or defect remediation server 135 in accordance with embodiments of the present invention. It should be appreciated that FIG. 5 provides only an illustration of one embodiment and does not imply any limitations with regard to the environments in which different embodiments may be implemented. Many modifications to the depicted environment may be made.

As depicted, the computer 10 includes communications fabric 12, which provides communications between computer processor(s) 14, memory 16, persistent storage 18, communications unit 20, and input/output (I/O) interface(s) 22. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Memory 16 and persistent storage 18 are computer readable storage media. In the depicted embodiment, memory 16 includes random access memory (RAM) 24 and cache memory 26. In general, memory 16 can include any suitable volatile or non-volatile computer readable storage media.

One or more programs may be stored in persistent storage 18 for execution by one or more of the respective computer processors 14 via one or more memories of memory 16. The persistent storage 18 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Communications unit 20, in these examples, provides for communications with other data processing systems or devices. In these examples, communications unit 20 includes one or more network interface cards. Communications unit 20 may provide communications through the use of either or both physical and wireless communications links.

I/O interface(s) 22 allows for input and output of data with other devices that may be connected to computer 10. For example, I/O interface 22 may provide a connection to external devices 28 such as a keyboard, keypad, a touch screen, and/or some other suitable input device. External devices 28 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 18 via I/O interface(s) 22. I/O interface(s) 22 may also connect to a display 30. Display 30 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Data relating to defect tracking and remediation (e.g., video data, user feedback data, performance data, baseline data, trained machine learning models, training data, knowledge base data, etc.) may be stored within any conventional or other data structures (e.g., files, arrays, lists, stacks, queues, records, etc.) and may be stored in any desired storage unit (e.g., database, data or other repositories, queue, etc.). The data transmitted between client device 105 and/or defect remediation server 135 may include any desired format and arrangement, and may include any quantity of any types of fields of any size to store the data. The definition and data model for any datasets may indicate the overall structure in any desired fashion (e.g., computer-related languages, graphical representation, listing, etc.).

Data relating to defect tracking and remediation (e.g., video data, user feedback data, performance data, baseline data, trained machine learning models, training data, knowledge base data, etc.) may include any information provided to, or generated by, client device 105 and/or defect remediation server 135. Data relating to defect tracking and remediation may include any desired format and arrangement, and may include any quantity of any types of fields of any size to store any desired data. The data relating to defect tracking and remediation may include any data collected about entities by any collection mechanism, any combination of collected information, and any information derived from analyzing collected information.

The present invention embodiments may employ any number of any type of user interface (e.g., Graphical User Interface (GUI), command-line, prompt, etc.) for obtaining or providing information (e.g., data relating to defect tracking and remediation), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

It will be appreciated that the embodiments described above and illustrated in the drawings represent only a few of the many ways of improving defect tracking and remediation.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., communications software, server software, client application 115, error detection module 120, screen recording module 125, server application 142, baseline analysis module 145, NLP module 150, defect analysis module 155, defect tracking module 160, etc.). These systems may include any types of monitors and input devices (e.g., keyboard, mouse, voice recognition, etc.) to enter and/or view information.

It is to be understood that the software (e.g., communications software, server software, client application 115, error detection module 120, screen recording module 125, server application 142, baseline analysis module 145, NLP module 150, defect analysis module 155, defect tracking module 160, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., communications software, server software, client application 115, error detection module 120, screen recording module 125, server application 142, baseline analysis module 145, NLP module 150, defect analysis module 155, defect tracking module 160, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to defect tracking and remediation). The database system may be implemented by any number of any conventional or other databases, data stores or storage structures (e.g., files, databases, data structures, data or other repositories, etc.) to store information (e.g., data relating to defect tracking and remediation). The database system may be included within or coupled to the server and/or client systems. The database systems and/or storage structures may be remote from or local to the computer or other processing systems, and may store any desired data (e.g., data relating to defect tracking and remediation).

The present invention embodiments may employ any number of any type of user interface (e.g., Graphical User Interface (GUI), command-line, prompt, etc.) for obtaining or providing information (e.g., data relating to defect tracking and remediation), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for any number of applications in the relevant fields, including, but not limited to, monitoring and improving SaaS-based applications by capturing client-side contextual details relating to the performance of such applications.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for defect tracking and remediation, the method comprising:
receiving, from a client computing device, video data corresponding to a recording of a graphical user interface of an application of the client computing device, wherein the video data is obtained in response to the application encountering an error;
obtaining feedback from a user of the client computing device by engaging the user via a natural language processing model;
analyzing the video data and the feedback to determine one or more operations to reproduce the error; and
providing one or more corrective actions, based on the determined one or more operations, to remediate the error in the application.

2. The computer-implemented method of claim 1, wherein determining the one or more operations to reproduce the error is further based on analyzing one or more network attributes selected from a group of: a network utilization attribute of a server in communication with the application, a network utilization attribute of the client computing device, a computing resource utilization attribute of the server, and a computing resource utilization attribute of the client computing device.

3. The computer-implemented method of claim 1, wherein determining the one or more operations to reproduce the error is further based on analyzing one or more modifications to the application since a previous version of the application.

4. The computer-implemented method of claim 1, wherein the error is identified based on one or more of: an error code reported by the client computing device, a wait time for an operation of the application that exceeds a threshold value, and a deviation of the application from a predetermined baseline computing resource utilization.

5. The computer-implemented method of claim 1, wherein the one or more operations to reproduce the error are analyzed to identify one or more other client computing devices vulnerable to the error, and further comprising:
transmitting a notification to the one or more other client computing devices to notify of the error.

6. The computer-implemented method of claim 1, wherein the error is associated with an error category, and wherein a span of the video data that is obtained is determined based on the error category.

7. The computer-implemented method of claim 1, wherein the error is tagged according to a view of the application being presented via the graphical user interface, and wherein the error is stored in a release notes document that includes known errors for each view of the application.

8. A computer system for defect tracking and remediation, the computer system comprising:
one or more computer processors;
one or more computer readable storage media;
program instructions stored on the one or more computer readable storage media for execution by at least one of the one or more computer processors, the program instructions comprising instructions to:
receive, from a client computing device, video data corresponding to a recording of a graphical user interface of an application of the client computing device, wherein the video data is obtained in response to the application encountering an error;
obtain feedback from a user of the client computing device by engaging the user via a natural language processing model;
analyze the video data and the feedback to determine one or more operations to reproduce the error; and
provide one or more corrective actions, based on the determined one or more operations, to remediate the error in the application.

9. The computer system of claim 8, wherein determining the one or more operations to reproduce the error is further based on analyzing one or more network attributes selected from a group of: a network utilization attribute of a server in communication with the application, a network utilization attribute of the client computing device, a computing resource utilization attribute of the server, and a computing resource utilization attribute of the client computing device.

10. The computer system of claim 8, wherein determining the one or more operations to reproduce the error is further based on analyzing one or more modifications to the application since a previous version of the application.

11. The computer system of claim 8, wherein the error is identified based on one or more of: an error code reported by the client computing device, a wait time for an operation of the application that exceeds a threshold value, and a deviation of the application from a predetermined baseline computing resource utilization.

12. The computer system of claim 8, wherein the one or more operations to reproduce the error are analyzed to identify one or more other client computing devices vulnerable to the error, and wherein the program instructions further comprise instructions to:
transmit a notification to the one or more other client computing devices to notify of the error.

13. The computer system of claim 8, wherein the error is associated with an error category, and wherein a span of the video data that is obtained is determined based on the error category.

14. The computer system of claim 8, wherein the error is tagged according to a view of the application being presented via the graphical user interface, and wherein the error is stored in a release notes document that includes known errors for each view of the application.

15. A computer program product for defect tracking and remediation, the computer program product comprising one or more computer readable storage media collectively having program instructions embodied therewith, the program instructions executable by a computer to cause the computer to:
receive, from a client computing device, video data corresponding to a recording of a graphical user interface of an application of the client computing device, wherein the video data is obtained in response to the application encountering an error;
obtain feedback from a user of the client computing device by engaging the user via a natural language processing model;
analyze the video data and the feedback to determine one or more operations to reproduce the error; and
provide one or more corrective actions, based on the determined one or more operations, to remediate the error in the application.

16. The computer program product of claim 15, wherein determining the one or more operations to reproduce the error is further based on analyzing one or more network attributes selected from a group of: a network utilization attribute of a server in communication with the application, a network utilization attribute of the client computing device, a computing resource utilization attribute of the server, and a computing resource utilization attribute of the client computing device.

17. The computer program product of claim 15, wherein determining the one or more operations to reproduce the error is further based on analyzing one or more modifications to the application since a previous version of the application.

18. The computer program product of claim 15, wherein the error is identified based on one or more of: an error code reported by the client computing device, a wait time for an operation of the application that exceeds a threshold value, and a deviation of the application from a predetermined baseline computing resource utilization.

19. The computer program product of claim 15, wherein the one or more operations to reproduce the error are analyzed to identify one or more other client computing devices vulnerable to the error, and wherein the program instructions further cause the computer to:
transmit a notification to the one or more other client computing devices to notify of the error.

20. The computer program product of claim 15, wherein the error is associated with an error category, and wherein a span of the video data that is obtained is determined based on the error category.
